(19) United States
(12) Patent Application Publication
(10) Pub. No.: US 2026/0067409 A1
(43) Pub. Date: Mar. 5, 2026

(54) IMAGE FORMING APPARATUS, CONTROL METHOD, AND NON-TRANSITORY COMPUTER-READABLE RECORDING MEDIUM

(71) Applicant: Konica Minolta, Inc., Tokyo (JP)

(72) Inventors: Kazuhiro TOMIYASU, Toyokawa-shi (JP); Hiroshi SUGIURA, Toyokawa-shi (JP)

(21) Appl. No.: 19/314,784

(22) Filed: Aug. 29, 2025

(30) Foreign Application Priority Data
Sep. 3, 2024 (JP) 2024-151164

(51) Int. Cl. H04N 1/00

(52) U.S. Cl. CPC H04N 1/0088; H04N 1/00244; H04N 2201/0094

(57) ABSTRACT

An image forming apparatus for executing virus detection processing on received data includes a hardware processor. The hardware processor is capable of executing either first acquisition process for downloading and acquiring a pattern file used in the virus detection processing from an external network or second acquisition process for downloading and acquiring the pattern file used in the virus detection processing from an internal network or a connected storage device. The hardware processor switches between the first acquisition process and the second acquisition process in accordance with a usage environment of the external network.

### CROSS REFERENCE TO RELATED APPLICATIONS

This application is based on Japanese Patent Application No. 2024 − 151164 filed on Sep. 3, 2024, the contents of which are incorporated herein by reference.

### BACKGROUND OF THE INVENTION

### Technical Field

The present invention relates to an image forming apparatus, a control method, and a non-transitory computer-readable recording medium. In particular, the present invention relates to a technique for updating a pattern file for detecting a computer virus (hereinafter simply referred to as "virus”) in the image forming apparatus.

### Description of Related Art

An image forming apparatus such as an MFP (Multifunction Peripherals) installed in an office is an apparatus shared by a plurality of users and has a plurality of functions such as a scanning function, a printing function, and a copying function. The image forming apparatus receives data to be printed and transmits image data generated by a scanning function via network. If the image forming apparatus is infected with a computer virus, the virus infection may spread to other apparatuses connected to the network. Furthermore, the image forming apparatus infected with the virus may leak confidential information such as customer information. Therefore, the image forming apparatuses in recent years have a virus detection function for preventing virus infection, similarly to general personal computers (PCs) and the like. Such the image forming apparatuses are disclosed in, for example, Japanese Unexamined Patent Publications No. JP2019-220111A, No. JP2020-119448A and No. JP2023-21234A.

A pattern file is used for virus detection. The pattern file is an electronic file that defines patterns, such as characteristics of viruses, and stores various virus patterns. The pattern file is sequentially updated to a file corresponding to the latest virus in a server device accessible via the Internet. Therefore, the image forming apparatus can detect the latest virus by downloading the latest pattern file from the server device by online communication via the Internet and using it for virus detection.

However, depending on an office environment in which the image forming apparatus is installed, the image forming apparatus might not be able to be connected to an external network such as the Internet. In such a case, the image forming apparatus cannot use the latest pattern file. On the other hand, the image forming apparatus can receive various kinds of data via an internal network such as a local area network (LAN) in the office. Therefore, if another device connected to the internal network is infected with the latest virus, the image forming apparatus may be infected with the virus due to data received from the other device.

Therefore, in order to protect the image forming apparatus from the latest virus, it is desirable to be able to update a pattern file used by the image forming apparatus even in an environment in which the image forming apparatus cannot be connected to an external network such as the Internet.

### SUMMARY OF THE INVENTION

The present invention has been devised in order to solve the above-described problems. That is, an object of the present invention is to provide an image forming apparatus, a control method, and a non-transitory computer-readable recording medium capable of appropriately updating a pattern file in accordance with a use environment of a user.

A first subject of the present invention is directed to an image forming apparatus for executing virus detection processing on received data.

According to an aspect of the first subject, an image forming apparatus includes a hardware processor. The hardware processor is capable of executing either first acquisition process for downloading and acquiring a pattern file used in the virus detection processing from an external network or second acquisition process for downloading and acquiring the pattern file used in the virus detection processing from an internal network or a connected storage device. The hardware processor switches between the first acquisition process and the second acquisition process in accordance with a usage environment of the external network.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 is a conceptual diagram illustrating an overall configuration of a network system including an image forming apparatus;

FIG. 2 is a block diagram illustrating an example of a hardware configuration of the image forming apparatus;

FIG. 3 is a block diagram illustrating a functional configuration of a controller;

FIG. 4 is a diagram illustrating an acquisition aspect of a pattern file by a first acquisition section;

FIG. 5 is a diagram illustrating an acquisition aspect of a pattern file by a second acquisition section;

FIG. 6 is a diagram illustrating an example of update processing by a file update section;

FIG. 7 is a diagram illustrating another example of update processing by the file update section;

FIG. 8 is a flowchart illustrating an example of a main processing procedure related to the update of the pattern file;

FIG. 9 is a flowchart illustrating an example of a detailed processing procedure of the file acquisition process;

FIG. 10 is a flowchart illustrating an example of a detailed processing procedure of the file update process;

FIG. 11 is a flowchart illustrating an example of a detailed processing procedure of the file update process;

FIG. 12 is a flowchart illustrating an example of a detailed processing procedure of the online acquisition process; and

FIG. 13 is a flowchart illustrating an example of a detailed processing procedure of the offline acquisition process.

### DETAILED DESCRIPTION OF EMBODIMENTS

Hereinafter, one or more embodiments of the present invention will be described with reference to the drawings. However, the scope of the invention is not limited to the disclosed embodiments. Note that in the embodiments described below, common elements are denoted by the same reference signs, and redundant description thereof is omitted.

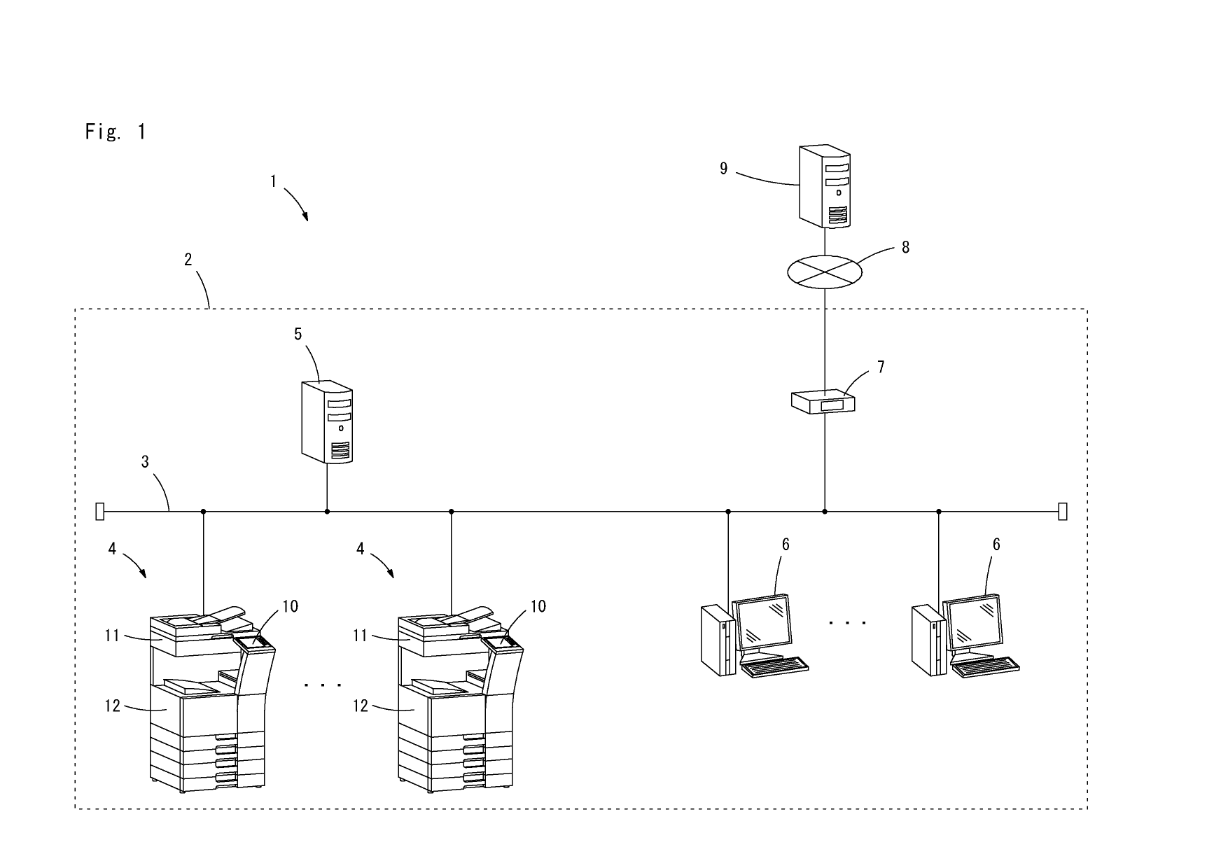

FIG. 1 is a conceptual diagram illustrating the overall configuration of a network system 1 including an image forming apparatus 4 according to an embodiment of the present invention. The network system 1 is a system in which an internal network 3, such as a LAN, installed in an office 2 and an external network 8, such as the Internet, are connected to each other via a relay device 7, such as a router. In the office 2, a plurality of image forming apparatuses 4, information processing apparatuses 5 and 6, and a relay device 7 are installed. The image forming apparatus 4, the information processing apparatuses 5 and 6, and the relay device 7 are all connected to the internal network 3 and can communicate with each other via the internal network 3. The relay device 7 is also connected to an external network 8, and can communicate with a server device 9 installed on a cloud such as the Internet. The server device 9 is an external server installed in an external environment different from the internal network 3 to which the image forming apparatus 4 is connected.

The image forming apparatus 4 is configured as, for example, an MFP, and has a plurality of functions such as a scanning function, a printing function, and a copying function. The image forming apparatus 4 includes an operation panel 10, a scanner unit 11, and a printer unit 12. The operation panel 10 is a user interface with which a user operates the image forming apparatus 4. When execution of a scan job is started in the image forming apparatus 4, the scanner unit 11 optically reads an image of a document set by a user and generates image data. In response to start of execution of a print job in the image forming apparatus 4, the printer unit 12 forms and outputs an image to be printed on a sheet such as a printing sheet.

The information processing apparatus 5 is a local server installed in the office 2. For example, the information processing apparatus 5 has a function of a file server. The information processing apparatus 5 shares a file with the image forming apparatus 4 and the information processing apparatus 6 connected to the internal network 3. The information processing apparatus 5 can access an external network 8 such as the Internet via the relay device 7, and can download various data via the external network 8.

The information processing apparatus 6 is a personal computer (PC) installed in the office 2. For example, the information processing apparatus 6 is a computer used by a user who works in the office 2. Similarly, to the information processing apparatus 5, the information processing apparatus 6 can access the external network 8 such as the Internet via the relay device 7, and can download various data via the external network 8.

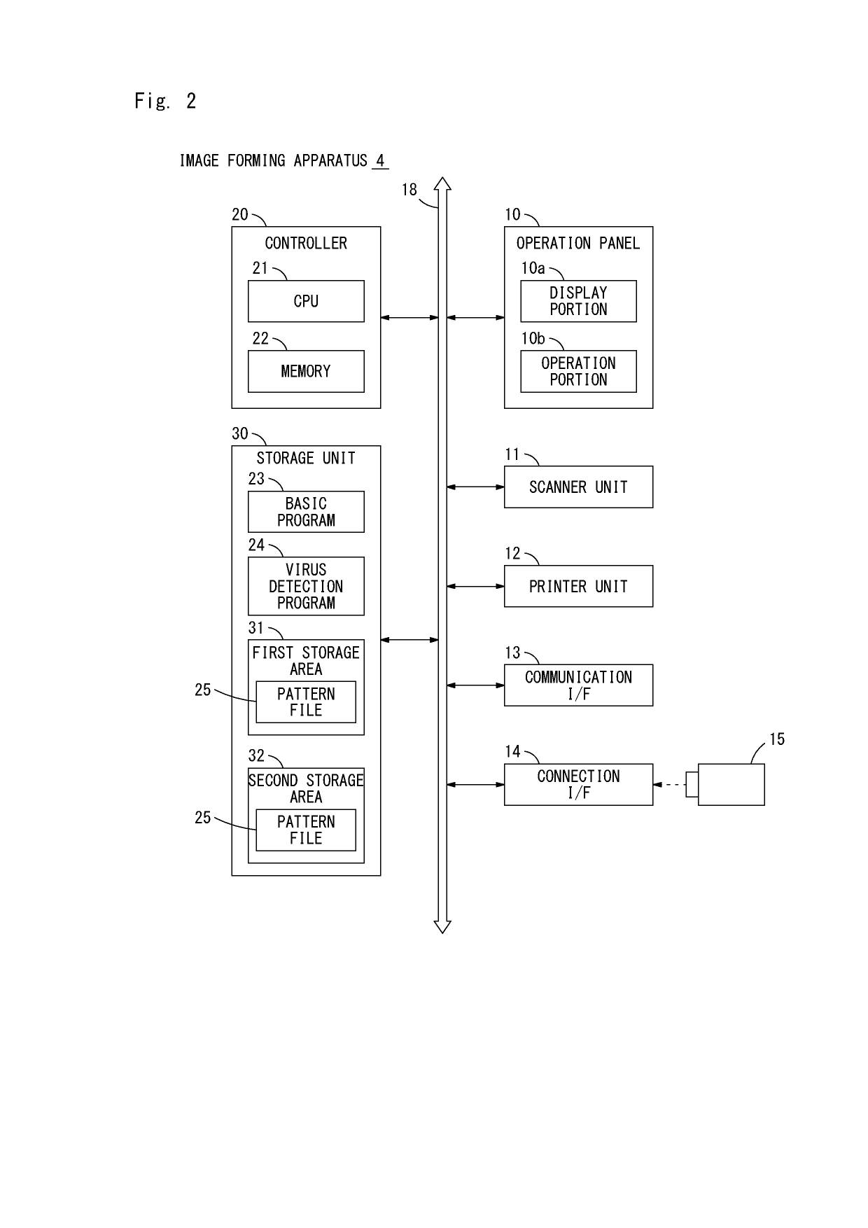

FIG. 2 is a block diagram illustrating an example of a hardware configuration of the image forming apparatus 4. The image forming apparatus 4 includes an operation panel 10, a scanner unit 11, a printer unit 12, a communication interface 13, a connection interface 14, a controller 20, and a storage unit 30. These units are connected to a bus 18 provided inside the image forming apparatus 4, and can perform data communication with each other via the bus 18.

The operation panel 10 includes a display portion 10a and an operation portion 10b. The display portion 10a is formed with, for example, a color liquid-crystal display, and displays various operation screens that can be operated by a user. The operation portion 10b is constituted by, for example, a touch screen device disposed on the screen of the display portion 10a, and receives an operation performed by the user on the operation screen.

The communication interface 13 connects the image forming apparatus 4 to the internal network 3 and performs communication via the internal network 3. The connection interface 14 is a connection unit for connecting a storage device 15 such as a USB memory device.

The controller 20 integrally controls the operation of the image forming apparatus 4. The controller 20 includes a CPU 21 and a memory 22. The CPU 21 is a hardware processor that reads and executes a computer-readable program stored in the storage unit 30. The memory 22 stores temporary information or data generated when the CPU 21 executes the program.

The storage unit 30 is a nonvolatile storage device constituted by, for example, a hard disk drive (HDD) or a solid state drive (SSD). The storage unit 30 stores a basic program 23 and a virus detection program 24 in advance. The basic program 23 is a program for controlling basic operation of the image forming apparatus 4. The virus detection program 24 is a program that causes a virus detection application for performing virus detection processing in the image forming apparatus 4 to function. Since the virus detection application is resident in the image forming apparatus 4, the image forming apparatus 4 can perform virus detection processing when transmitting and receiving data via the internal network 3.

In addition, the storage unit 30 includes two storage areas of a first storage area 31 and a second storage area 32 in order to store the pattern file 25 used for the virus detection process.

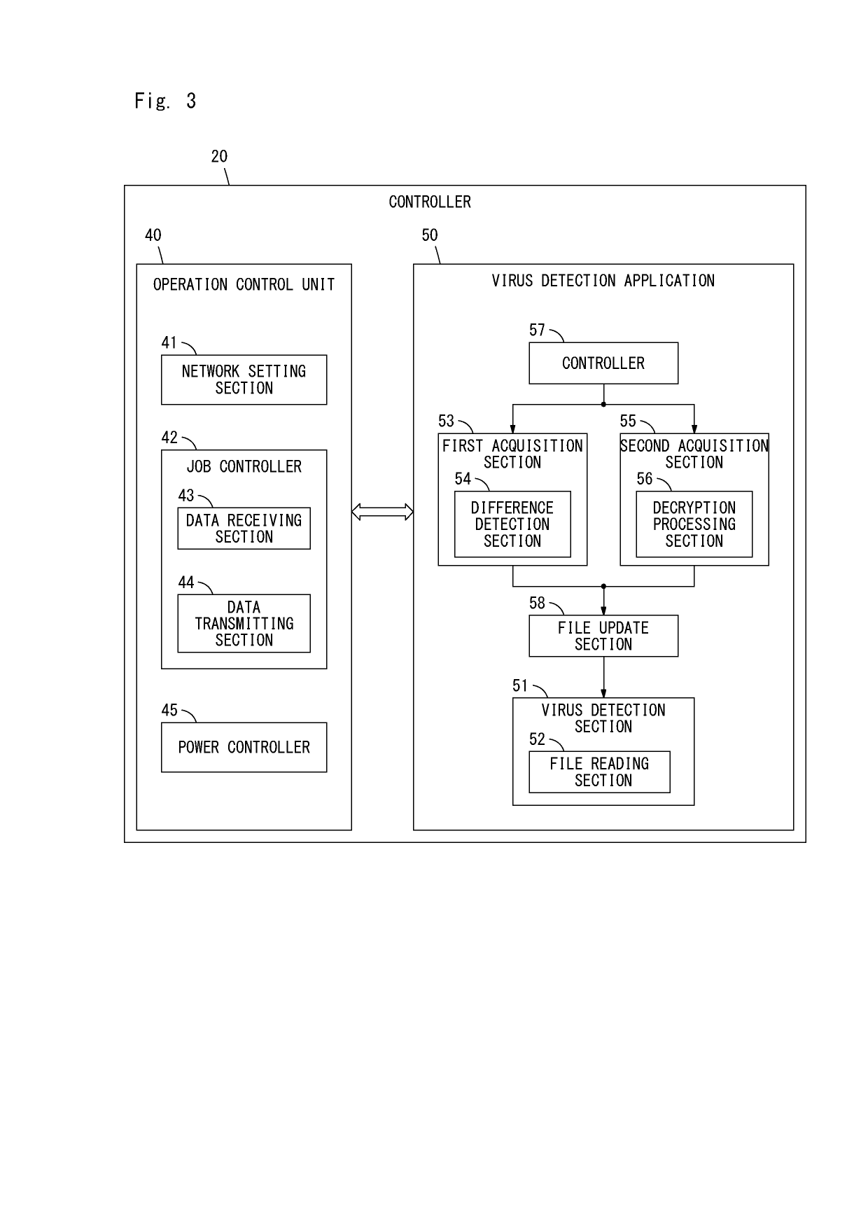

FIG. 3 is a block diagram illustrating a functional configuration of the controller 20. When the image forming apparatus 4 is powered on, the CPU 21 of the controller 20 reads the basic program 23 and the virus detection program 24 from the storage unit 30 and executes them. The basic program 23 is executed by the CPU 21 to cause the controller 20 to function as an operation controller 40. The virus detection program 24 is executed by the CPU 21 after the operation controller 40 is activated. The virus detection program 24 is executed by the CPU 21 to cause the controller 20 to function as a virus detection application 50. The virus detection application 50 is resident in the controller 20 while the image forming apparatus 4 is powered on, except for a state of being switched to the power saving mode.

The operation controller 40 includes a network setting section 41, a job controller 42, and a power controller 45.

The network setting section 41 performs network setting of the image forming apparatus 4. For example, an administrator of the image forming apparatus 4 can operate the operation panel 10 to cause the image forming apparatus 4 to enter the administrator setting mode. The network setting section 41 functions in the administrator setting mode, and performs network setting based on a setting operation by the administrator. For example, the administrator can perform network setting by operating an administrator setting screen displayed on the display portion 10a in the administrator setting mode.

Further, in the administrator setting mode, the administrator can take the pattern file 25 used for the virus detection processing into the image forming apparatus 4 from the storage device 15 connected to the connection interface 14.

The network setting section 41 sets, based on a setting operation by the administrator, whether to permit connection to the external network 8. For example, an administrator may make a setting to prohibit the image forming apparatus 4 from connecting to the external network 8 from the viewpoint of security. In this case, the network setting section 41 prohibits the image forming apparatus 4 from connecting to the external network 8 via the relay device 7. The network setting section 41 records such network setting in setting information and manages the setting information.

The job controller 42 controls execution of a job in the image forming apparatus 4. For example, the job controller 42 controls execution of the job designated by a user by controlling operations of the scanner unit 11 and the printer unit 12. The job controller 42 includes a data receiving section 43 and a data transmitting section 44. The data receiving section 43 receives data to be subjected to execution of the job via the internal network 3. For example, the information processing apparatus 6 sends image data to be printed as a print job to the image forming apparatus 4. The data receiving section 43 receives data included in such a print job or the like. The data transmitting section 44 transmits data via the internal network 3. For example, the job controller 42 executes a scan job to generate image data. The data transmitting section 44 transmits such image data to another information processing apparatus 6 or the like connected to the internal network 3.

The power controller 45 controls a power state of the image forming apparatus 4. For example, the power controller 45 switches between the normal energization mode and the power saving mode. The normal energization mode is a mode in which power is supplied to each part of the image forming apparatus 4 and is a power mode in which the image forming apparatus 4 can execute a job. The power saving mode is a mode in which power consumption is suppressed by cutting off power supply to at least a part of the image forming apparatus 4, and is a power mode in which the image forming apparatus 4 cannot execute a job. In the normal energization mode, when a state in which the image forming apparatus 4 is not used by a user continues for a predetermined time, the power controller 45 shifts the power mode from the normal energization mode to the power saving mode. In the power saving mode, when a user's operation on the operation panel 10 is detected or when data is received via the internal network 3, the power controller 45 returns the power mode from the power saving mode to the normal energization mode. When returning from the power saving mode to the normal energization mode, the power controller 45 performs a return process. The return process requires a certain time from the start to the end.

The virus detection application 50 executes virus detection processing at an appropriate timing in order to prevent the image forming apparatus 4 from being infected with a virus. The virus detection application 50 includes a virus detection section 51, a first acquisition section 53, a second acquisition section 55, a controller 57, and a file update section 58.

When the job controller 42 receives data via the internal network 3, the virus detection section 51 performs virus detection processing on the received data. When the job controller 42 transmits data to the outside via the internal network 3, the virus detection section 51 performs virus detection processing on the data to be transmitted. When a virus is not detected by the virus detection processing, the virus detection section 51 permits execution of subsequent processing on the received data and the transmission target data. On the other hand, when a virus is detected by the virus detection processing, the virus detection section 51 discards the received data and the transmission target data to prevent virus infection.

The virus detection section 51 includes a file reading section 52. The file reading section 52 reads the pattern file 25 from one of the first storage area 31 and the second storage area 32. For example, the file reading section 52 reads the pattern file 25 from one of the first storage area 31 and the second storage area 32 when the image forming apparatus 4 is activated or when the image forming apparatus 4 returns from the power saving mode to the normal energization mode. The pattern file 25 is an electronic file that defines a pattern such as a feature of a virus. Patterns of various viruses are accumulated in the pattern file 25. The virus detection section 51 executes virus detection processing based on the pattern file 25 read by the file reading section 52. Therefore, when data to be subjected to virus detection processing includes a pattern that matches a pattern accumulated in the pattern file 25, the virus detection section 51 detects that the data includes a virus.

The pattern file 25 is sequentially updated to cope with a new virus. A server device 9 installed on a cloud such as the Internet publishes and provides the latest pattern file 25 that enables detection of a new virus to an external network 8.

The first acquisition section 53 and the second acquisition section 55 acquire the latest pattern file 25. The first acquisition section 53 and the second acquisition section 55 acquire the pattern files 25 by different methods.

The controller 57 causes one of the first acquisition section 53 and the second acquisition section 55 to function and controls an operation of acquiring the latest pattern file 25. The controller 57 switches which of the first acquisition section 53 and the second acquisition section 55 is to be operated according to the use environment of the external network 8. Specifically, the controller 57 refers to the setting information managed by the network setting section 41, and causes one of the first acquisition section 53 and the second acquisition section 55 to function based on the setting information. When the connection of the image forming apparatus 4 to the external network 8 is permitted, the controller 57 brings the first acquisition section 53 into operation. On the other hand, when the connection of the image forming apparatus 4 to the external network 8 is prohibited, the controller 57 brings the second acquisition section 55 into operation.

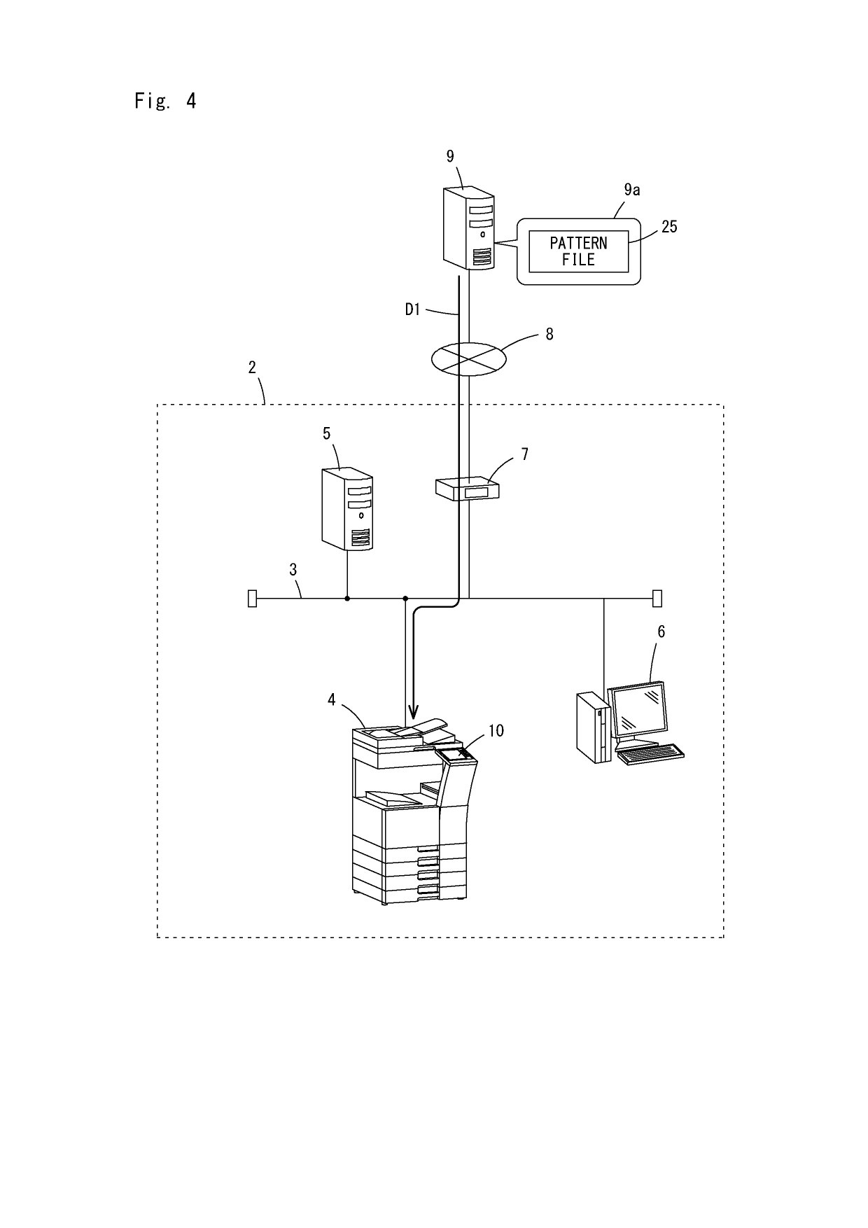

The first acquisition section 53 is accessible to the server device 9 via the external network 8 and directly downloads and acquires the pattern file 25 from the server device 9. FIG. 4 is a diagram exemplifying an acquisition operation of the pattern file 25 by the first acquisition section 53. As illustrated in FIG. 4, the first acquisition section 53 accesses the server device 9 via the external network 8. The server device 9 includes a storage section 9a that stores a pattern file 25 used in virus detection processing, and discloses a storage area of the storage section 9a to the external network 8. Address information for accessing the storage section 9a of the server device 9 is registered in advance in the first acquisition section 53. The first acquisition section 53 accesses the server device 9 via the external network 8 on the basis of the address information. Next, the first acquisition section 53 determines whether or not the pattern file 25 held in the server device 9 has been updated. When the pattern file 25 in the server device 9 has been updated, the first acquisition section 53 downloads and acquires the latest pattern file 25 from the server device 9 as indicated by an arrow D1 in FIG. 4.

The first acquisition section 53 includes a difference detection section 54. The difference detection section 54 detects a difference between the pattern file 25 held in the image forming apparatus 4 and the latest pattern file 25 stored in the server device 9. For example, the difference detection section 54 makes a version comparison between the pattern file 25 held in the image forming apparatus 4 and the pattern file 25 stored in the server device 9. The difference detection section 54 detects, based on the result of the version comparison, a difference file for updating the pattern file 25 of the image forming apparatus 4 to the latest version. For example, the server device 9 publishes a list of difference files between different versions. The difference detection section 54 detects a difference file by referring to the list. Note that the difference detection section 54 may notify the server device 9 of the version of the pattern file 25 held in the image forming apparatus 4, and detect the difference file based on a response from the server device 9.

When downloading the pattern file 25 from the server device 9, the first acquisition section 53 downloads the difference file detected by the difference detection section 54. The data amount of the difference file is smaller than the entire data amount of the pattern file 25. Therefore, the first acquisition section 53 can efficiently acquire the latest pattern file 25 by downloading the difference file from the server device 9. In this way, the first acquisition section 53 connects to the server device 9 via the external network 8 and acquires the pattern file 25 online from the server device 9.

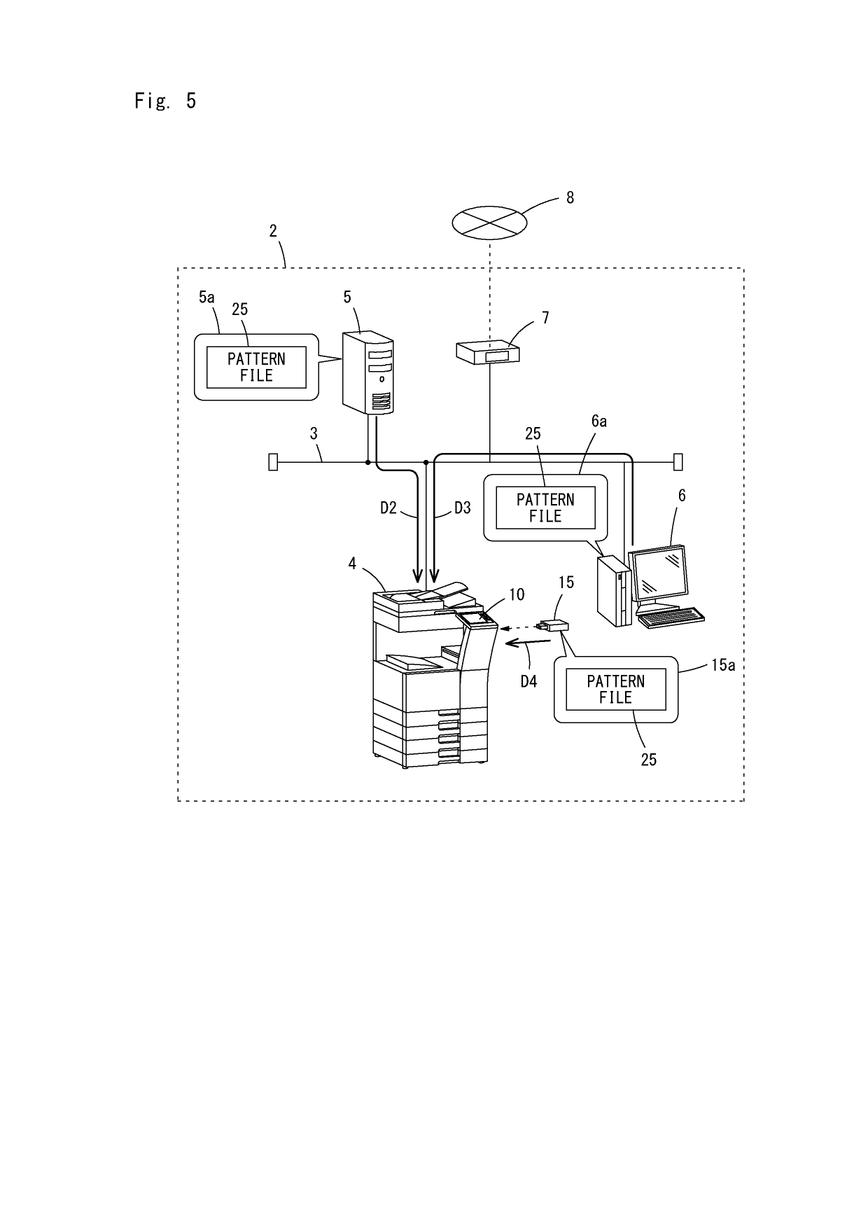

The second acquisition section 55 acquires the pattern file 25 in the environment of the office 2 without connecting to the external network 8. FIG. 5 is a diagram exemplifying an acquisition operation of the pattern file 25 by the second acquisition section 55. As illustrated in FIG. 5, the information processing apparatus 5 includes a shared folder 5a that can be shared and accessed in the internal network 3. The information processing apparatus 6 also includes a shared folder 6a that can be shared and accessed in the internal network 3.

For example, the administrator of the image forming apparatus 4 operates the information processing apparatus 5 or 6 to connect the information processing apparatuses 5 or 6 to the external network 8 and access the server device 9. Then, the administrator stores the latest pattern file 25 held in the server device 9 in the shared folder 5a or 6a of the information processing apparatus 5 or 6 in advance. At this time, the information processing apparatus 5 or 6 acquires the encrypted pattern file 25 from the server device 9 and store it in the shared folder 5a or 6a. By encrypting the pattern file 25 to be stored in the shared folder 5a or 6a, it is possible to prevent the pattern file 25 from being tampered with.

Further, a configuration may be adopted in which the pattern file acquisition program is installed in the information processing apparatus 5 or 6, and the information processing apparatus 5 or 6 periodically and automatically accesses the server device 9. In this case, the information processing apparatus 5 or 6 can automatically download the latest pattern file 25 from the server device 9 and automatically save it in the shared folder 5a or 6a.

The second acquisition section 55 accesses one of the shared folders 5a and 6a via the internal network 3. The addresses (paths) of the shared folders 5a and 6a to be accessed by the second acquisition section 55 are set in the second acquisition section 55 in advance. For example, when the shared folder 5a of the information processing apparatus 5 is set as the access destination, the second acquisition section 55 accesses the shared folder 5a via the internal network 3 and determines whether the pattern file 25 is stored in the shared folder 5a. When the pattern file 25 is stored in the shared folder 5a, the second acquisition section 55 downloads and acquires the pattern file 25 from the shared folder 5a of the information processing apparatus 5 as indicated by an arrow D2 in FIG. 5. When the shared folder 6a of the information processing apparatus 6 is set as the access destination, the second acquisition section 55 downloads and acquires the pattern file 25 from the shared folder 6a of the information processing apparatus 6 as indicated by an arrow D3 in FIG. 5.

Furthermore, when the storage device 15 is attached to the connection interface 14, the second acquisition section 55 can also acquire the pattern file 25 from the storage device 15. That is, the second acquisition section 55 determines whether or not the pattern file 25 is saved in the storage area 15a of the storage device 15. If the pattern file 25 is stored in the storage area 15a, the second acquisition section 55 downloads and acquires the pattern file 25 from the storage device 15, as indicated by arrow D4 in FIG. 5.

In this way, the second acquisition section 55 acquires the pattern file 25 from a device different from the server device 9 without connecting to the server device 9. Such an acquisition form is referred to as offline acquisition.

The pattern file 25 acquired by the second acquisition section 55 is encrypted from the viewpoint of falsification prevention as described above. Therefore, the second acquisition section 55 includes a decryption processing section 56. The decryption processing section 56 decrypts the pattern file 25 acquired from the information processing apparatus 5 or 6 or the storage device 15. Through the decryption process performed by the decryption processing section 56, the pattern file 25 is restored to an electronic file that can be used in the virus detection process.

The controller 57 selectively causes one of the first acquisition section 53 and the second acquisition section 55 to function based on the network setting by the network setting section 41. That is, the controller 57 performs control such that the latest pattern file 25 can be appropriately acquired even when the use environment of the external network 8 is different.

The file update section 58 functions when the pattern file 25 is acquired by the first acquisition section 53 or the second acquisition section 55. The file update section 58 updates the pattern file 25 used when the virus detection section 51 performs the virus detection process to the pattern file 25 acquired by the first acquisition section 53 or the second acquisition section 55. The update by the file update section 58 allows the virus detection section 51 to perform virus detection processing based on the latest pattern file 25.

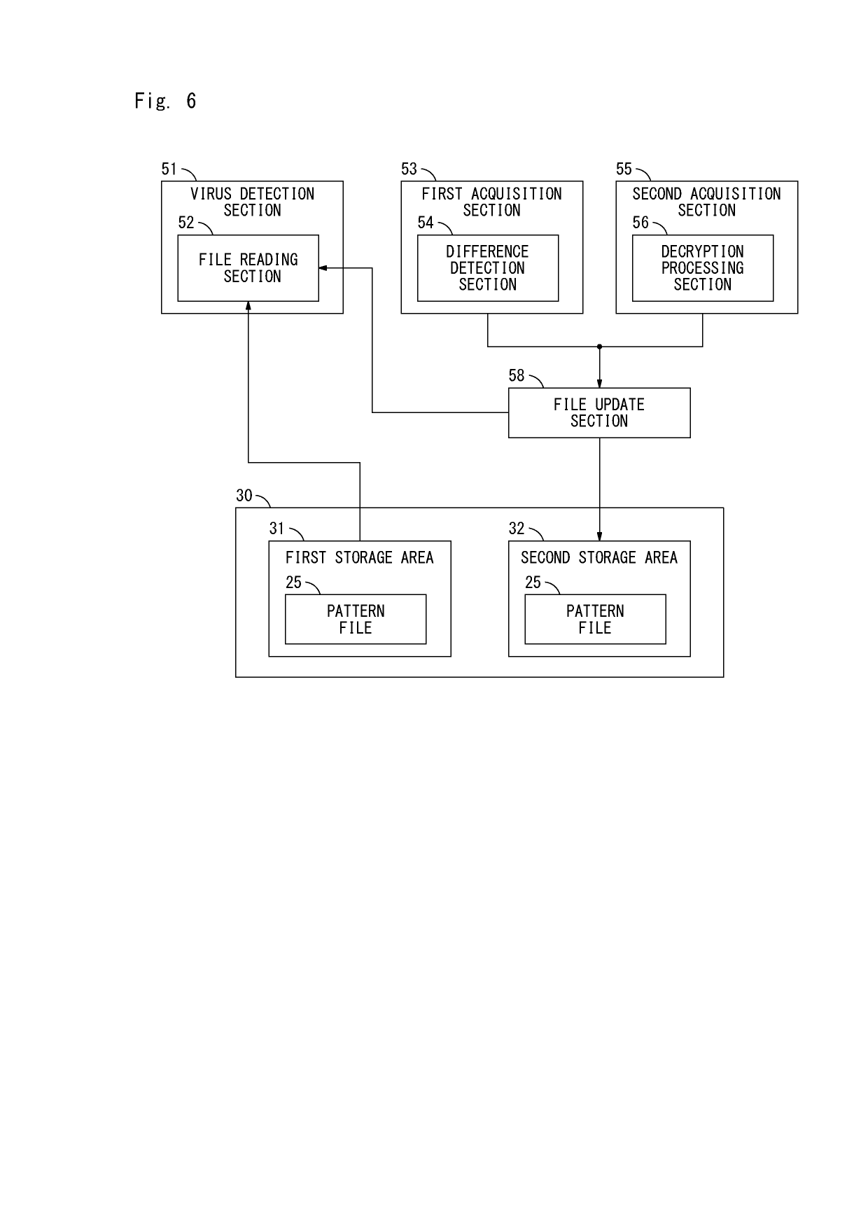

FIG. 6 is a diagram illustrating an example of update processing performed by the file update section 58. FIG. 6 illustrates a state in which the file reading section 52 of the virus detection section 51 reads the pattern file 25 in the first storage area 31 and uses the pattern file 25 for the virus detection process. In this case, the file update section 58 updates the pattern file 25 stored in the second storage area 32 to the pattern file 25 acquired by the first acquisition section 53 or the second acquisition section 55.

When the pattern file 25 is acquired by the first acquisition section 53, the pattern file 25 is the difference file. Therefore, the file update section 58 adds and updates the difference file acquired by the first acquisition section 53 to the pattern file 25 in the second storage area 32. As a result, the pattern file 25 in the second storage area 32 becomes the latest pattern file 25.

In addition, in a case where the pattern file 25 is acquired by the second acquisition section 55, the pattern file 25 is not a difference file but includes all files. Therefore, the file update section 58 replaces and updates the entire pattern file 25 stored in the second storage area 32 with the pattern file 25 acquired by the second acquisition section 55. As a result, the pattern file 25 in the second storage area 32 is overwritten and updated to the latest pattern file 25.

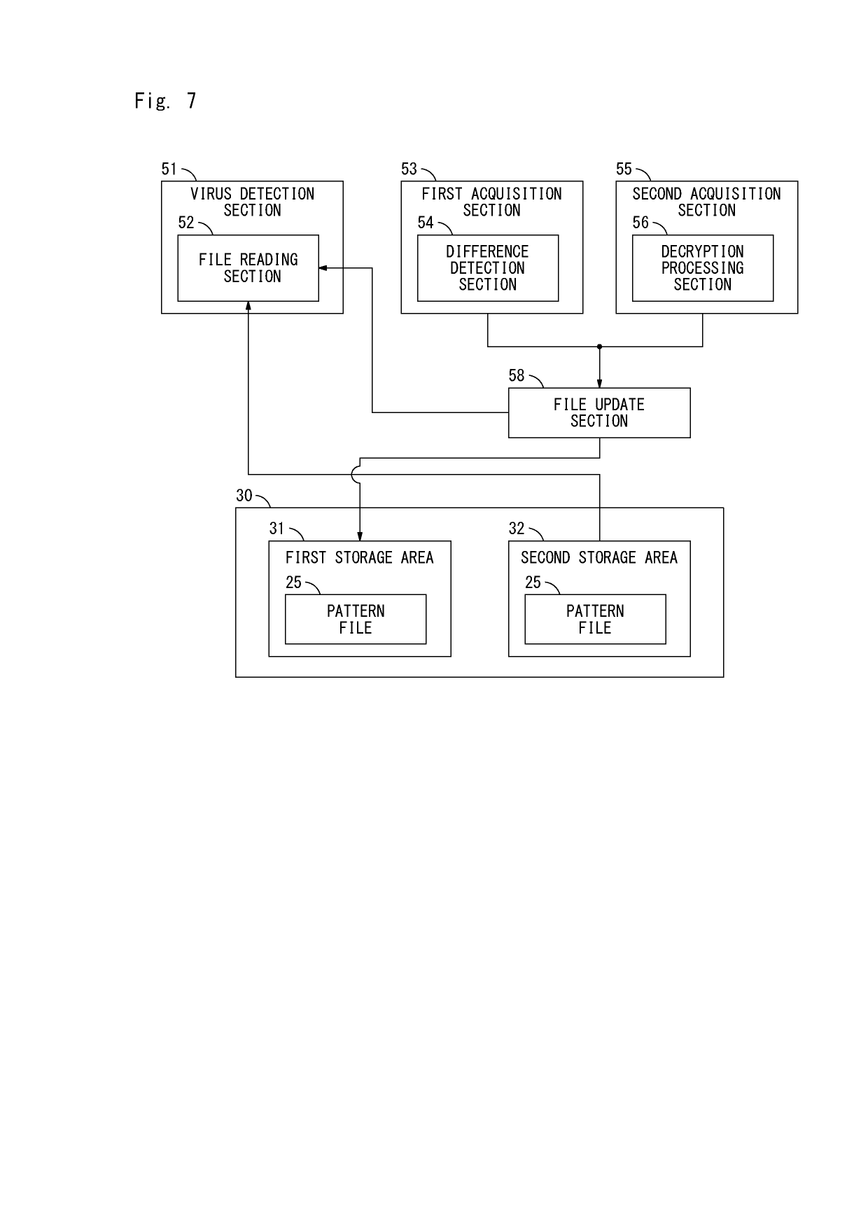

FIG. 7 is a diagram illustrating another example of update processing performed by the file update section 58. FIG. 7 illustrates a state in which the file reading section 52 of the virus detection section 51 reads the pattern file 25 in the second storage area 32 and uses the pattern file 25 for the virus detection process. In this case, the file update section 58 updates the pattern file 25 stored in the first storage area 31 to the pattern file 25 acquired by the first acquisition section 53 or the second acquisition section 55.

When the pattern file 25 is acquired by the first acquisition section 53, the pattern file 25 is the difference file. In this case, the file update section 58 adds and updates the difference file acquired by the first acquisition section 53 to the pattern file 25 in the first storage area 31. As a result, the pattern file 25 in the first storage area 31 becomes the latest pattern file 25.

In addition, in a case where the pattern file 25 is acquired by the second acquisition section 55, the pattern file 25 is not the difference file but includes all files. Therefore, the file update section 58 replaces and updates the entire pattern file 25 stored in the first storage area 31 with the pattern file 25 acquired by the second acquisition section 55. As a result, the pattern file 25 in the first storage area 31 is overwritten and updated with the latest pattern file 25.

When the pattern file 25 in one of the first storage area 31 and the second storage area 32 is updated as described above, the file update section 58 instructs the file reading section 52 to change the storage area. Thus, the file reading section 52 changes the storage area at the next time of reading the pattern file 25. When the file reading section 52 receives a change instruction from the file update section 58, the file reading section 52 may immediately change the storage area and read the pattern file 25.

The virus detection application 50 configured as described above is automatically activated with the turning on of the power of the image forming apparatus 4, and is resident in the controller 20. Therefore, when the image forming apparatus 4 receives data via the internal network 3, the virus detection application 50 can perform virus detection processing on the received data. Furthermore, when the image forming apparatus 4 transmits data via the internal network 3, the virus detection application 50 can also perform virus detection processing on the transmitted data. That is, the virus detection application 50 resident in the controller 20 executes the virus detection processing in accordance with the execution of the job by the image forming apparatus 4.

The virus detection application 50 acquires the latest pattern file 25 at a predetermined timing. Then, the virus detection application 50 updates the pattern file 25 used for the virus detection processing to the latest pattern file 25 at the timing when the job is not executed in the image forming apparatus 4. The timing at which no job is executed in the image forming apparatus 4 includes, for example, a timing immediately after activation of the image forming apparatus 4, a timing of switching from the normal energization mode to the power saving mode, and a timing of returning from the power saving mode to the normal energization mode. The virus detection application 50 can update the pattern file 25 without affecting the virus detection processing by updating the pattern file 25 at the timing when no job is executed. Hereinafter, a specific processing procedure by such a virus detection application 50 will be described.

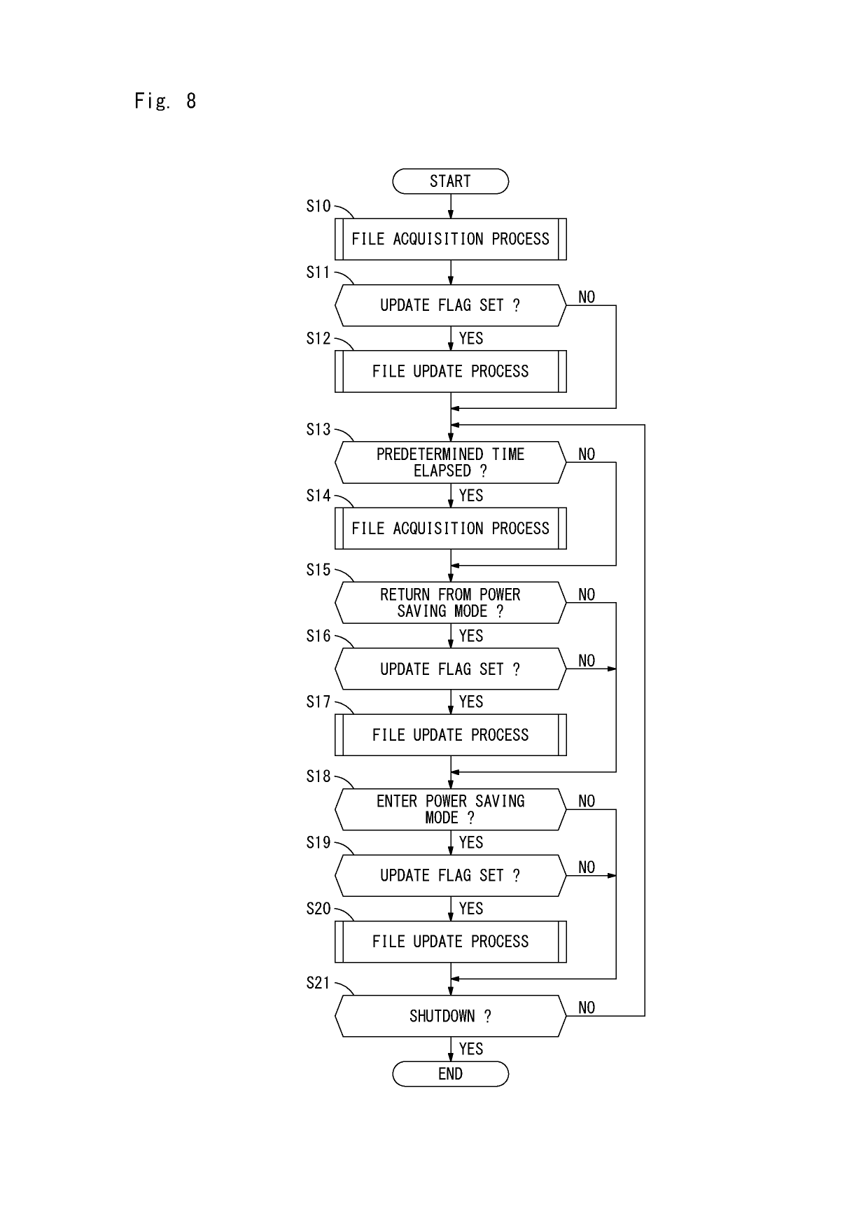

FIGS. 8 to 13 are flowcharts illustrating an example of a processing procedure related to updating of the pattern file 25 by the virus detection application 50. The virus detection application 50 is activated with the turning on of the power of the image forming apparatus 4, and starts processing based on the flowchart of FIG. 8.

When activated by the controller 20 of the image forming apparatus 4, the virus detection application 50 executes file acquisition process (step S10). In the file acquisition process, processing of acquiring the pattern file 25 from the storage device 15 based on the operation by the administrator in the administrator setting mode, processing of acquiring the pattern file 25 based on the network setting, and the like are performed. Details of the file acquisition process (step S10) will be described later.

When performing file acquisition process (step S10) at the time of activation, the virus detection application 50 determines whether or not an update flag has been set by the file acquisition process (step S11). The update flag is information indicating that the latest pattern file 25 has been acquired. If the update flag is set (YES in step S11), the virus detection application 50 executes file update process (step S12). No job is executed at a timing immediately after the activation of the image forming apparatus 4. Therefore, when the latest pattern file 25 is acquired immediately after the activation, the virus detection application 50 executes the file update process (step S12) as it is. When the update flag is not set by the file acquisition process (NO in step S11), the process of step S12 is skipped. Details of the file update process (step S12) will be described later.

Thereafter, the virus detection application 50 determines whether a predetermined time has elapsed (step S13). That is, the virus detection application 50 determines whether or not a predetermined time has elapsed since the last file acquisition process (step S10 or S14). If the predetermined period of time has elapsed (YES in step S13), the virus detection application 50 executes the file acquisition process again (step S14). Note that if the predetermined time period has not elapsed (NO in step S13), the process of step S14 is skipped.

Next, the virus detection application 50 determines whether it is time for the image forming apparatus 4 to return from the power saving mode (step S15). If it is time to return from the power saving mode (YES in step S15), the virus detection application 50 determines whether the update flag has been set (step S16). If the update flag is set (YES in step S16), the virus detection application 50 executes file update process (step S17). That is, the virus detection application 50 executes the file update process while the power controller 45 is performing the return process. If it is not the timing to return from the power saving mode (NO in step S15), the processes of steps S16 and S17 are skipped. If the update flag is not set (NO in step S16), the process of step S17 is skipped.

Next, the virus detection application 50 determines whether it is time for the image forming apparatus 4 to enter the power saving mode (step S18). If it is time to enter the power saving mode (YES in step S18), the virus detection application 50 determines whether or not the update flag is set (step S19). If the update flag is set (YES in step S19), the virus detection application 50 executes file update process (step S20). That is, the virus detection application 50 executes the file update process while the processing for switching to the power saving mode is being performed by the power controller 45. If it is not the timing to enter the power saving mode (NO in step S18), the processes of steps S19 and S20 are skipped. If the update flag is not set (NO in step S19), the process of step S20 is skipped.

Next, the virus detection application 50 determines whether shutdown of the image forming apparatus 4 has been started (step S21). If the shutdown has not been started (NO in step S21), the processing by the virus detection application 50 returns to step S13. In this case, the virus detection application 50 repeatedly executes the processing of step S13 and subsequent steps. On the other hand, if the shutdown has been started (YES in step S21), the process of the virus detection application 50 ends.

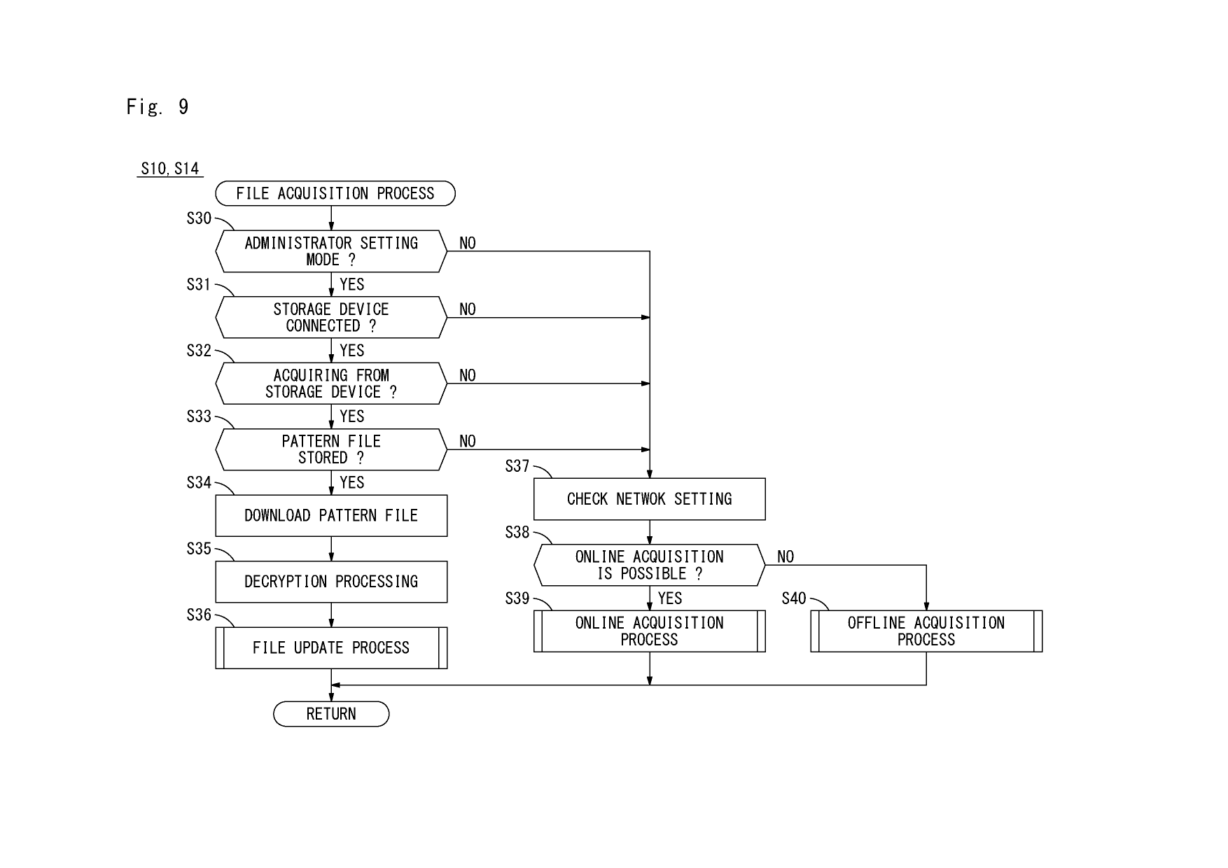

FIG. 9 is a flowchart illustrating an example of a detailed processing procedure of the file acquiring process (steps S10 and S14). When starting the file acquisition process (steps S10 and S14), the virus detection application 50 determines whether or not the current operation mode is the administrator setting mode (step S30).

If the mode is the administrator setting mode (YES in step S30), the virus detection application 50 determines whether or not the storage device 15 is connected to the connection interface 14 (step S31). When the storage device 15 is connected (YES in step S31), the virus detection application 50 determines whether or not there is an instruction to acquire the pattern file 25 from the storage device 15 (step S32). That is, the virus detection application 50 determines whether or not an instruction from the administrator has been accepted in the administrator setting mode. If the instruction by the administrator has been accepted (YES in step S32), the virus detection application 50 checks whether or not the pattern file 25 is saved in the storage device 15 (step S33). If the pattern file 25 is stored in the storage device 15 (YES in step S33), the virus detection application 50 downloads and acquires the pattern file 25 from the storage device 15 (step S34).

The pattern file 25 stored in the storage device 15 is encrypted. Therefore, the virus detection application 50 performs decryption processing on the acquired pattern file 25 to restore the pattern file 25 usable in the virus detection processing (step S35). Thereafter, the virus detection application 50 executes file update processing (step S36).

On the other hand, when the mode is not the administrator setting mode (NO in step S30), the process by the virus detection application 50 proceeds to step S37. If the storage device 15 is not connected (NO in step S31), the process by the virus detection application 50 also proceeds to step S37. When the instruction from the administrator is not received (NO in step S32), the process by the virus detection application 50 also proceeds to step S37. Furthermore, when no pattern file 25 is saved in the storage device 15 (NO in step S33), the processing by the virus detection application 50 also proceeds to step S37.

The virus detection application 50 checks network settings (step S37). The virus detection application 50 then determines whether it is possible to connect to the external network 8 and acquire the pattern file 25 online (step S38). If online acquiring is possible (YES in step S38), the virus detection application 50 executes online acquisition process (step S39). That is, the virus detection application 50 accesses the server device 9 via the external network 8 and starts a process of acquiring the pattern file 25 from the server device 9. Details of the online acquisition process (step S39) will be described later.

If the pattern file 25 cannot be acquired online (NO in step S38), the virus detection application 50 executes an offline acquisition process (step S40). That is, the virus detection application 50 starts the process of acquiring the pattern file 25 without accessing the server device 9. Details of the offline acquisition process (step S40) will be described later.

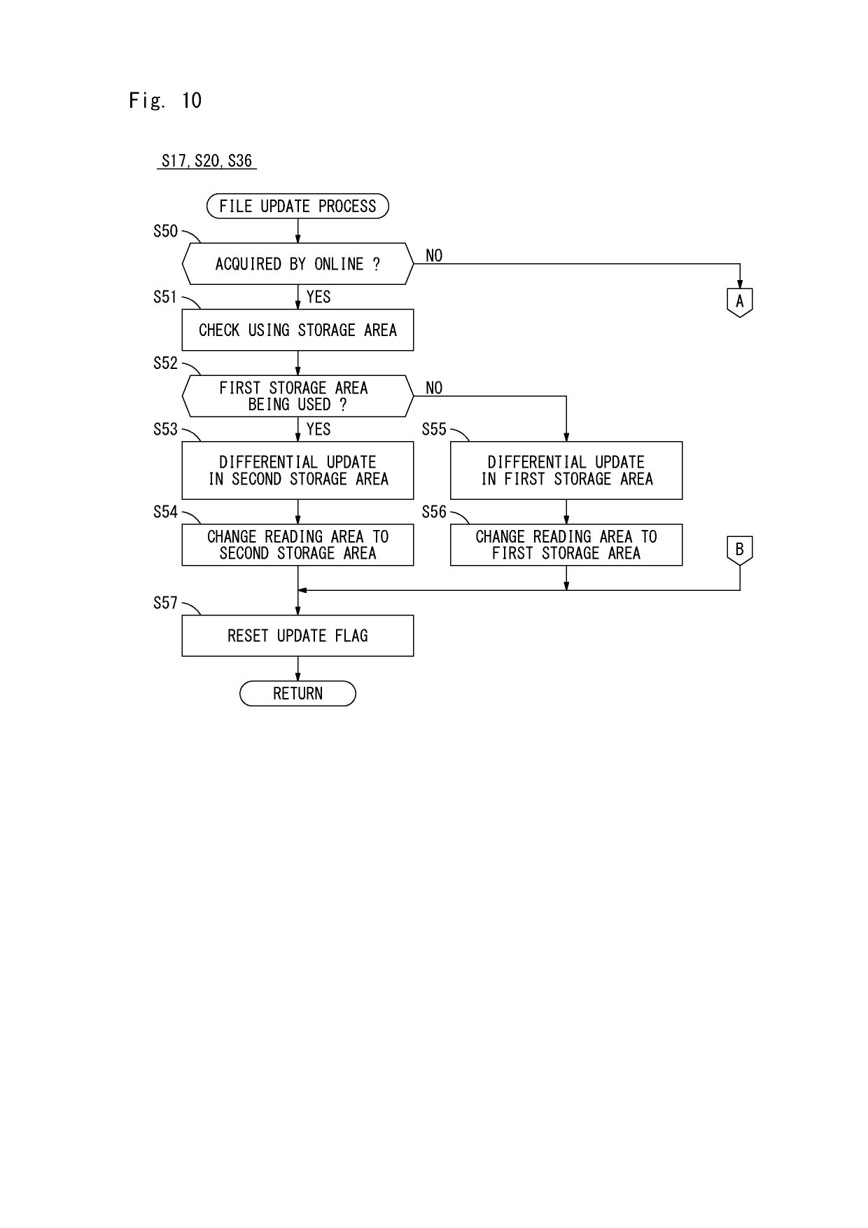

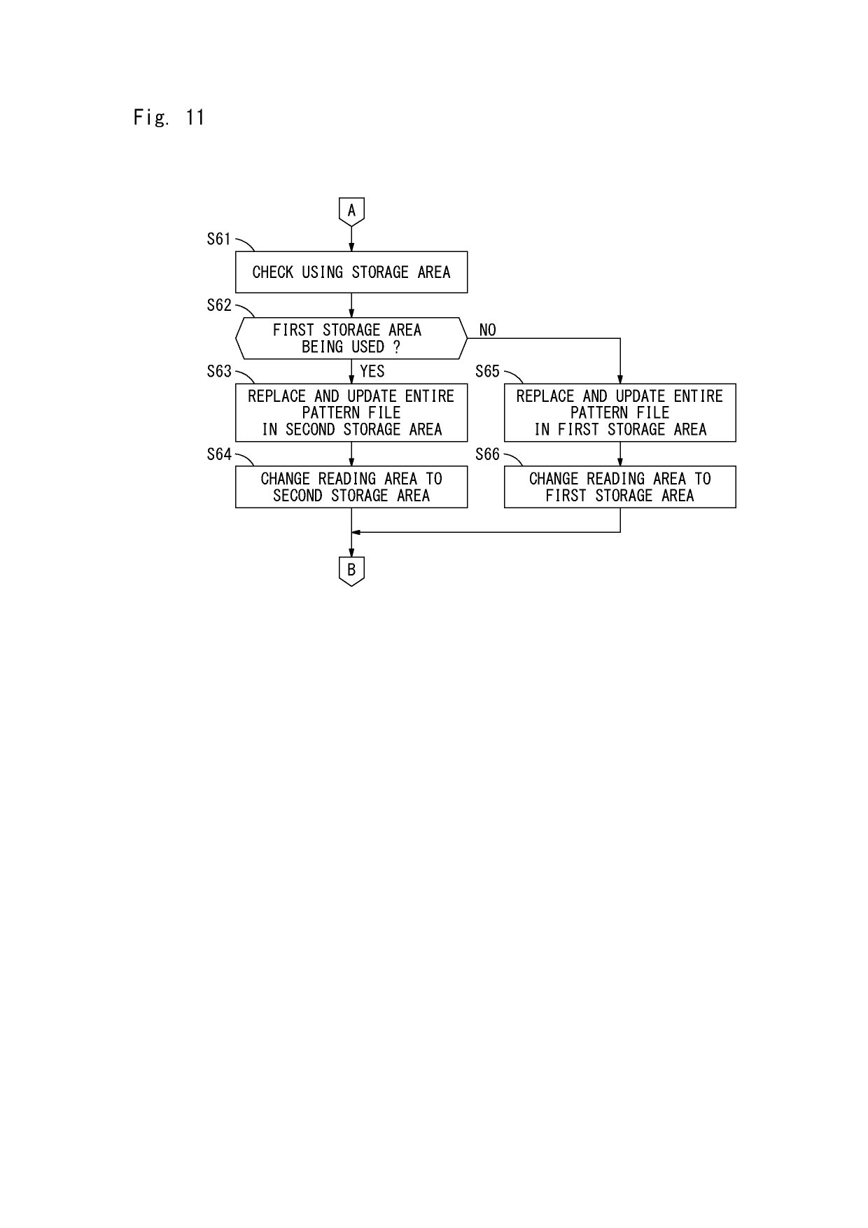

Next, FIGS. 10 and 11 are flowcharts showing an example of a detailed processing procedure of the file update process (steps S17, S20, and S36). This file update process is performed after the pattern file 25 is acquired. When starting the file update process, as illustrated in FIG. 10, the virus detection application 50 determines whether or not the pattern file 25 has been acquired online (step S50). If the virus detection application 50 has downloaded and acquired the pattern file 25 from the server device 9 via the external network 8, the virus detection application 50 determines that the acquisition of the pattern file 25 is online acquisition. If the virus detection application 50 has downloaded and acquired the pattern file 25 from a device different from the server device 9, the virus detection application 50 determines that the pattern file 25 is to be acquired not online but offline.

If the pattern file 25 has been acquired online (YES in step S50), the virus detection application 50 has acquired the pattern file 25 as the difference file. In this case, the virus detection application 50 checks the storage area of the pattern file 25 currently used by the virus detection section 51 (step S51). That is, the virus detection application 50 confirms from which of the first storage area 31 and the second storage area 32 the pattern file 25 is read by the virus detection section 51. Next, the virus detection application 50 determines whether the pattern file 25 in the first storage area 31 is being used by the virus detection section 51 (step S52).

If the pattern file 25 in the first storage area 31 is in use (YES in step S52), the virus detection application 50 differentially updates the pattern file 25 in the second storage area 32 (step S53). That is, the virus detection application 50 adds the difference file of the pattern file 25 acquired online from the server device 9 to the pattern file 25 in the second storage area 32 for update. As a result, the pattern file 25 in the second storage area 32 is updated to the latest pattern file 25. Subsequently, the virus detection application 50 changes the area to be read by the virus detection section 51 from the first storage area 31 to the second storage area 32 (step S54). Thus, the virus detection section 51 reads the latest pattern file 25 from the second storage area 32 and executes the virus detection process.

In contrast, if the pattern file 25 in the second storage area 32 is in use (NO in step S52), the virus detection application 50 differentially updates the pattern file 25 in the first storage area 31 (step S55). That is, the virus detection application 50 adds the difference file of the pattern file 25 acquired online from the server device 9 to the pattern file 25 in the first storage area 31 for update. As a result, the pattern file 25 in the first storage area 31 is updated to the latest pattern file 25. Subsequently, the virus detection application 50 changes the area to be read by the virus detection section 51 from the second storage area 32 to the first storage area 31 (step S56). As a result, the virus detection section 51 reads the latest pattern file 25 from the first storage area 31 and executes the virus detection process.

Thereafter, when the update flag is set, the virus detection application 50 resets the update flag (step S57). Furthermore, it is preferable that, after the virus detection section 51 reads the latest pattern file 25, the virus detection application 50 also updates, with the latest pattern file 25, the pattern file 25 in the storage areas that have not been updated.

On the other hand, when the pattern file 25 has been acquired offline (NO in step S50), the process by the virus detection application 50 proceeds to the flowchart of FIG. 11. The virus detection application 50 checks the storage area of the pattern file 25 currently used by the virus detection section 51 (step S61). That is, the virus detection application 50 confirms from which of the first storage area 31 and the second storage area 32 the pattern file 25 is read by the virus detection section 51. The virus detection application 50 determines whether the pattern file 25 in the first storage area 31 is being used by the virus detection section 51 (step S62).

If the pattern file 25 in the first storage area 31 is being used (YES in step S62), the virus detection application 50 replaces and updates the entire pattern file 25 in the second storage area 32 (step S63). In the case of offline acquisition, the virus detection application 50 has acquired all the files of the latest pattern file 25. Therefore, the virus detection application 50 updates the second storage area 32 by replacing all the files of the pattern file 25 in the second storage area 32 with all the files of the pattern file 25 acquired offline. As a result, the pattern file 25 in the second storage area 32 is updated to the latest pattern file 25. Next, the virus detection application 50 changes the area to be read by the virus detection section 51 from the first storage area 31 to the second storage area 32 (step S64). As a result, the virus detection section 51 reads the latest pattern file 25 from the second storage area 32 and executes the virus detection process. Also in this case, after the virus detection section 51 reads the latest pattern file 25, the virus detection application 50 preferably updates the pattern file 25 in the storage area that has not been updated to the latest pattern file 25.

In contrast, if the pattern file 25 in the second storage area 32 is being used (NO in step S62), the virus detection application 50 replaces and updates the entire pattern file 25 in the first storage area 31 (step S65). That is, the virus detection application 50 updates the first storage area 31 by replacing all the files of the pattern file 25 in the first storage area 31 with all the files of the pattern file 25 acquired offline. Thus, the pattern file 25 in the first storage area 31 is updated to the latest pattern file 25. Subsequently, the virus detection application 50 changes the area to be read by the virus detection section 51 from the second storage area 32 to the first storage area 31 (step S66). As a result, the virus detection section 51 reads the latest pattern file 25 from the first storage area 31 and executes the virus detection process. Also in this case, after the virus detection section 51 reads the latest pattern file 25, the virus detection application 50 preferably updates the pattern file 25 in the storage area that has not been updated to the latest pattern file 25.

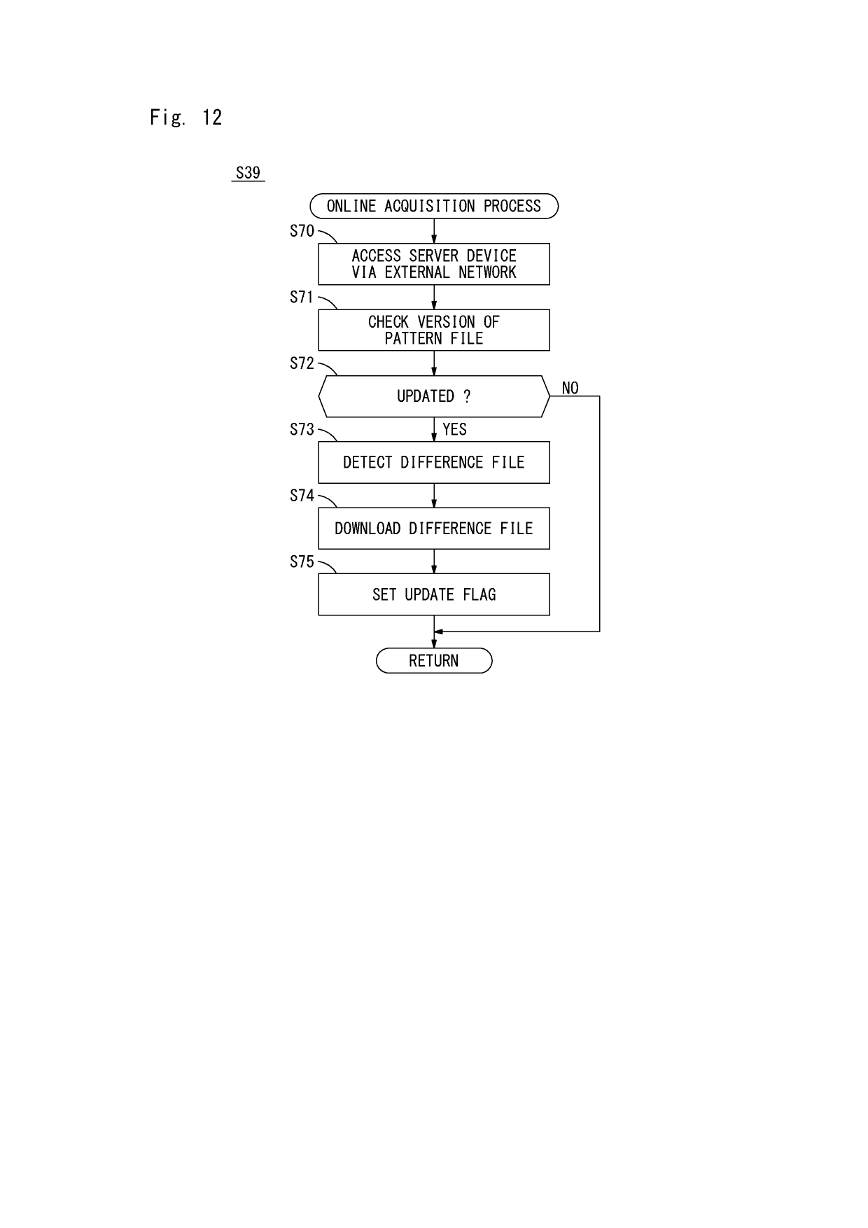

Next, FIG. 12 is a flowchart illustrating an example of the detailed processing procedure of the online acquisition process (step S39). When starting the online acquisition process, the virus detection application 50 accesses the server device 9 via the external network 8 (step S70). The virus detection application 50 checks the version of the pattern file 25 published on the server device 9 (step S71). As a result of checking the version, the virus detection application 50 determines whether or not the pattern file 25 on the server device 9 has been updated (step S72). If the pattern file 25 in the server device 9 has not been updated (NO in step S72), the virus detection application 50 ends the online acquisition process without acquiring the pattern file 25.

In contrast, when the pattern file 25 in the server device 9 has been updated (YES in step S72), the virus detection application 50 detects the difference file acquired from the server device 9 (step S73). That is, the virus detection application 50 detects the difference file between the pattern file 25 of the image forming apparatus 4 and the pattern file 25 of the server device 9. Next, the virus detection application 50 downloads the difference file for update from the server device 9 (step S74). When the difference file is normally acquired from the server device 9, the virus detection application 50 sets the update flag (step S75). Thus, the online acquisition processing ends.

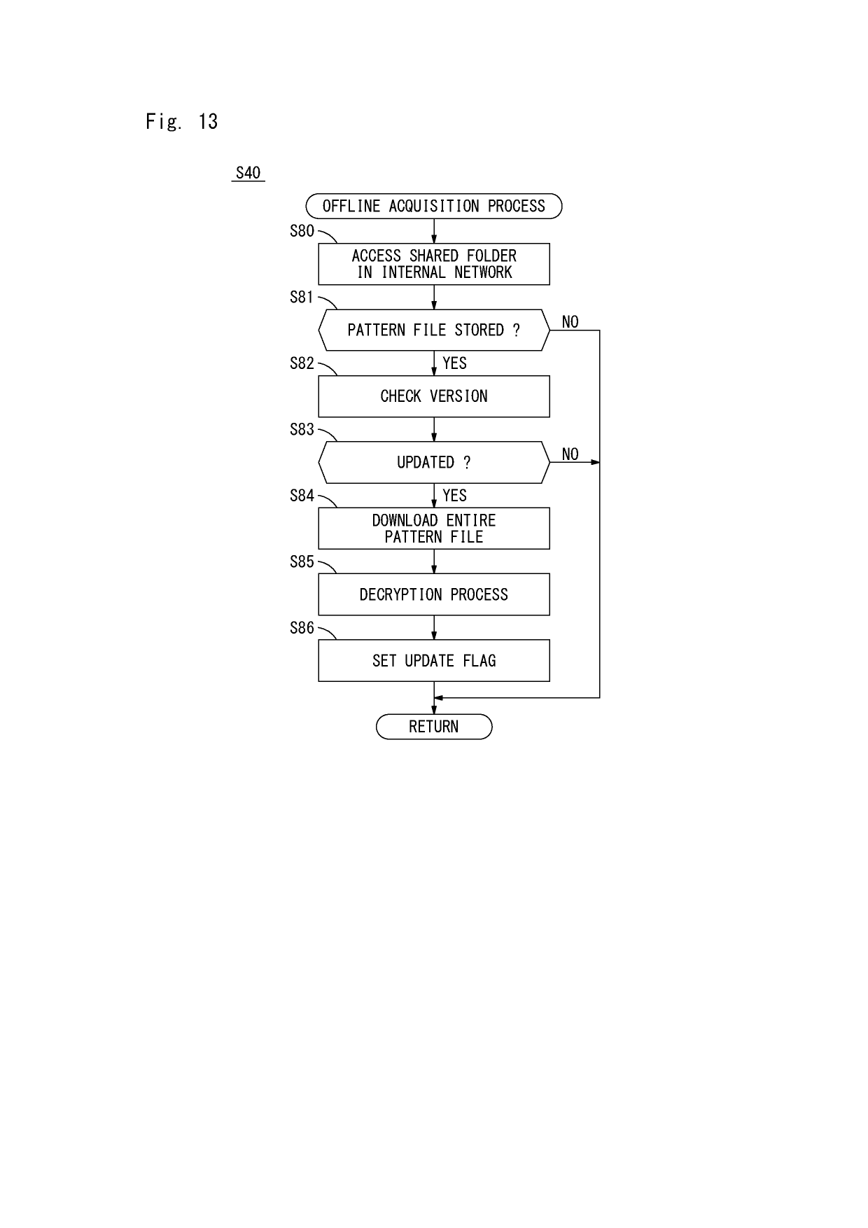

Next, FIG. 13 is a flowchart illustrating an example of a detailed processing procedure of the offline acquisition process (step S40). When starting the offline acquisition process, the virus detection application 50 accesses the shared folder 5a or 6a designated in advance in the internal network 3 (step S80). The virus detection application 50 determines whether or not the pattern file 25 is stored in the shared folder 5a or 6a (step S81). If the pattern file 25 is not stored in the shared folder 5a or 6a (NO in step S81), the offline acquisition process ends.

If the pattern file 25 is stored in the shared folder 5a or 6a (YES in step S81), the virus detection application 50 checks the version of the pattern file 25 in the shared folder 5a or 6a (step S82). The virus detection application 50 determines whether or not the pattern file 25 of the shared folder 5a or 6a has been updated based on the confirmation of the version (step S83). If the pattern file 25 of the shared folder 5a or 6a has not been updated (NO in step S83), the offline acquisition process ends.

On the other hand, if the pattern file 25 in the shared folder 5a or 6a has been updated (YES in step S83), the virus detection application 50 downloads and acquires the entire pattern file 25 from the shared folder 5a or 6a (step S84). At this time, the pattern file 25 to be acquired is encrypted. Therefore, upon acquiring the pattern file 25, the virus detection application 50 performs decryption processing to restore the pattern file 25 that can be used in the virus detection processing (step S85). When the decryption processing of the pattern file 25 is completed, the virus detection application 50 sets the update flag (step S86). Thus, the offline acquisition process ends.

As described above, the virus detection application 50 switches between online acquisition and offline acquisition of the pattern file 25 in accordance with the network setting in the image forming apparatus 4. Furthermore, if the storage device 15 is connected to the image forming apparatus 4, the virus detection application 50 can also download and acquire the pattern file 25 from the storage device 15. Therefore, even in a case where the image forming apparatus 4 is used in an environment in which the image forming apparatus 4 cannot be connected to the external network 8 such as the Internet, the virus detection application 50 can acquire the latest pattern file 25. Therefore, the virus detection application 50 can detect the latest virus by performing the virus detection process using the latest pattern file 25.

As described above, the image forming apparatus 4 of the present exemplary embodiment includes the first acquisition section 53, the second acquisition section 55, and the controller 57. The first acquisition section 53 downloads and acquires the pattern file 25 to be used in the virus detection processing from the external network 8. The second acquisition section 55 downloads and acquires the pattern file 25 from the internal network 3 or the connected storage device 15. Then, the controller 57 switches which of the first acquisition section 53 and the second acquisition section 55 is to be operated in accordance with the use environment of the external network 8 of the image forming apparatus 4.

The image forming apparatus 4 having such a configuration can acquire the latest pattern file 25 from the external network 8 by activating the first acquisition section 53, provided that the image forming apparatus 4 is connectable to the external network 8. In an environment in which the image forming apparatus 4 cannot be connected to the external network 8, the image forming apparatus 4 can acquire the latest pattern file 25 from the internal network 3 or the connected storage device 15 by operating the second acquisition section 55. Therefore, even in an environment where the image forming apparatus 4 is not connectable to the external network 8 such as the Internet, the pattern file 25 to be used in virus detection processing can be appropriately updated in the image forming apparatus 4.

As illustrated in FIG. 1, a plurality of image forming apparatuses 4 may be installed in the office 2. In that case, the same network setting is applied to the plurality of image forming apparatuses 4. When each image forming apparatus 4 can be connected to the external network 8, each image forming apparatus 4 can individually access the server device 9 via the external network 8 to acquire the latest pattern file 25 from the external network 8.

On the other hand, when the connection to the external network 8 is prohibited in each image forming apparatus 4, each image forming apparatus 4 cannot acquire the latest pattern file 25 from the server device 9 via the external network 8. In this case, each image forming apparatus 4 can download and acquire the pattern file 25 from the shared folder 5a or 6a of the information processing apparatus 5 or 6 connected to the internal network 3. At this time, even if the versions of the pattern files 25 held in the respective image forming apparatuses 4 are different, all the files of the latest pattern file 25 are stored in the shared folder 5a or 6a. Therefore, each image forming apparatus 4 can update its own pattern file 25 to the latest version by acquiring the pattern file 25 from the shared folder 5a or 6a.

A preferred embodiment of the present invention has been described above. However, the present invention is not limited to the content described in the above embodiment, and various modification examples are applicable.

For example, the above-described embodiment mainly illustrates the case where the external network 8 is the Internet. However, the external network 8 is not limited to the Internet.

Furthermore, the above embodiment illustrates the case where the virus detection program 24 is stored in advance in the storage unit 30 of the image forming apparatus 4. However, the virus detection program 24 is not limited to the one previously installed in the image forming apparatus 4. That is, the above-described virus detection program 24 can be a target of transaction independently. In this case, the virus detection program 24 may be provided in a state of being recorded in a non-transitory computer-readable recording medium such as a CD-ROM. The virus detection program 24 may be provided in a downloadable form via a network such as the Internet.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus for executing virus detection processing on received data, comprising a hardware processor, wherein
the hardware processor is capable of executing either first acquisition process for downloading and acquiring a pattern file used in the virus detection processing from an external network or second acquisition process for downloading and acquiring the pattern file used in the virus detection processing from an internal network or a connected storage device, and
switches between the first acquisition process and the second acquisition process in accordance with a usage environment of the external network.

2. The image forming apparatus according to claim 1, wherein
the hardware processor executes the first acquisition process to acquire the pattern file in a case of a usage environment connectable to the external network.

3. The image forming apparatus according to claim 1, wherein
the hardware processor executes the second acquisition process to acquire the pattern file in a usage environment in which connection to the external network is not permitted.

4. The image forming apparatus according to claim 1, wherein
in the first acquisition process, the hardware processor detects a difference file between the pattern file stored in an external server connected to the external network and the pattern file used in the virus detection processing, and downloads the difference file from the external network.

5. The image forming apparatus according to claim 1, wherein
the hardware processor downloads, in the second acquisition process, the pattern file from a shared folder of an information processing apparatus connected to the internal network.

6. The image forming apparatus according to claim 1, further comprising:
a connection interface that connects the storage device; wherein
the hardware processor downloads, in the second acquisition process, the pattern file from the storage device connected to the connection interface.

7. The image forming apparatus according to claim 1, wherein
the hardware processor downloads, in the second acquisition process, an entirety of the pattern file to be used in the virus detection processing.

8. The image forming apparatus according to claim 1, wherein
the hardware processor downloads, in the second acquisition process, an encrypted pattern file and decrypts the encrypted pattern file after the download.

9. The image forming apparatus according to claim 1, wherein
the hardware processor updates the pattern file used in the virus detection processing to the pattern file acquired by the first acquisition process or the second acquisition process at a timing when a job is not executed.

10. The image forming apparatus according to claim 9, wherein
the hardware processor updates the pattern file at the time of activation after power-on.

11. The image forming apparatus according to claim 9, wherein
the hardware processor updates the pattern file when returning from power saving mode.

12. The image forming apparatus according to claim 9, wherein
the hardware processor updates the pattern file at the time of transition from normal energization mode to power saving mode.

13. The image forming apparatus according to claim 9, wherein
the hardware processor updates the pattern file immediately after downloading the pattern file from the storage device by the second acquisition process.

14. The image forming apparatus according to claim 9, further comprising:
a storage unit including a first storage area and a second storage area in which the pattern file is stored, wherein
when the pattern file is read from one of the first storage area and the second storage area by the virus detection processing, the hardware processor updates the pattern file stored in the other of the first storage area and the second storage area.

15. The image forming apparatus according to claim 14, wherein
after updating the pattern file, the hardware processor switches a reading target of the pattern file by the virus detection processing from the one storage area to the other storage area.

16. A method for controlling an image forming apparatus that performs virus detection processing on received data, the method comprising:
performing one of first acquisition process of downloading and acquiring a pattern file used in the virus detection processing from an external network and second acquisition process of downloading and acquiring the pattern file used in the virus detection processing from an internal network or a connected storage device; and
switching between the first acquisition process and the second acquisition process depending on a usage environment of the external network.

17. A non-transitory computer-readable recording medium storing a computer-readable program to be executed by a hardware processor of an image forming apparatus for performing virus detection processing on received data, the program causing the hardware processor to perform:
executing one of a first acquisition process of acquiring a pattern file to be used in the virus detection processing by downloading the pattern file from an external network and a second acquisition process of acquiring the pattern file to be used in the virus detection processing by downloading the pattern file from an internal network or connected storage devices; and
switching between the first acquisition process and the second acquisition process depending on a usage environment of the external network.
